(19) United States
(12) Patent Application Publication
(10) Pub. No.: US 2025/0369548 A1
(43) Pub. Date: Dec. 4, 2025

(54) TELESCOPIC WATER PIPE

(71) Applicant: Yongkang Longying fly industry and trade Co., Ltd., Jinhua (CN)

(72) Inventor: FEILONG LYU, Yongkang (CN)

(21) Appl. No.: 18/675,523

(22) Filed: May 28, 2024

(51) Int. Cl. F16L 51/02

(52) U.S. Cl. CPC F16L 51/022

(57) ABSTRACT

The present disclosure discloses a telescopic water pipe, including a first connector, a second connector, and an outer sleeve. Two ends on a left side and a right side of the outer sleeve are respectively connected to the first connector and the second connector. A corrugated pipe is also placed in the outer sleeve. A left end and a right end of the corrugated pipe are respectively connected to the first connector and the second connector. The outer sleeve includes a woven tape and elastic filaments. The woven tape and the elastic filaments are seamlessly woven into the outer sleeve. When water passes, the outer sleeve and the corrugated pipe extend horizontally to both sides. The present disclosure has the advantages of simple structure, convenience in use, high water pressure resistance, and capability of prolonging the service life.

### TECHNICAL FIELD

The present disclosure relates to the technical field of water pipes, and in particular, to a telescopic water pipe.

### BACKGROUND

Water pipes are widely and frequently used in our daily lives, such as watering flowers, cleaning cars, and irrigation in agriculture. The existing water pipes are basically made of silicone or rubber materials, with only one separate pipe body. One end of the pipe body is a connector, and the other end is a water outlet. However, the biggest problem is that pipe bodies cannot extend and retract and occupy large space when the water pipes are used or stored. The prior art discloses a telescopic garden hose. Extending and retracting functions of a water pipe are realized through an inner layer structure and an outer layer structure. The maximum extending length of the telescopic garden hose may be six times the original length. However, when this telescopic water pipe structure is used, an inner pipe and an outer sleeve will be continuously elongated and shortened alternately. The inner pipe and the outer sleeve rub against each other continuously, and a friction coefficient is large, which easily leads to cracks in the inner pipe and the outer sleeve, and affects the service life of the water pipe. Meanwhile, the water pipe with this structure is prone to rupture when a water pressure reaches a certain value, so it is not resistant to high water pressure.

### SUMMARY

A technical problem to be solved by the present disclosure is to provide a telescopic water pipe, which is simple in structure, convenient to use, and high in water pressure resistance, and can effectively prolong the service life.

In order to solve the above technical problem, the present disclosure adopts the following technical solutions:

A telescopic water pipe includes a first connector, a second connector, and an outer sleeve. Two ends on a left side and a right side of the outer sleeve are respectively connected to the first connector and the second connector. A corrugated pipe is also placed in the outer sleeve. A left end and a right end of the corrugated pipe are respectively connected to the first connector and the second connector. The outer sleeve includes a woven tape and elastic filaments. The woven tape and the elastic filaments are seamlessly woven into the outer sleeve. When water passes, the outer sleeve and the corrugated pipe extend horizontally to both sides.

A further technical solution is that a water inlet/outlet is formed in each of the first connector and the second connector for water to inflow and outflow.

A further technical solution is that a silicone gasket is also mounted in the second connector and is configured to realize better sealing property when connected to an external connecting piece, for example, realizing sealing when connected to a water faucet.

A further technical solution is that the corrugated pipe is a plastic corrugated pipe, and is more wear-resistant and durable compared with a silicone pipe.

A further technical solution is that the woven tape is made of nylon fibers, of course, may be made of other wear-resistant materials, for example, a polyester fiber material.

A further technical solution is that a protective sleeve is also fixed to each of the first connector and the second connector for preventing the fracture of deformation of the water pipe when bended for a plurality of times, which is a conventional technology.

The present disclosure has the following beneficial effects:

The telescopic water pipe of the present disclosure includes the outer sleeve. The corrugated pipe is placed in the outer sleeve. The elastic filaments are seamlessly woven in the outer sleeve, so that the outer sleeve has elasticity. The corrugated pipe and the outer sleeve can extend horizontally, and the mutual friction between the corrugated pipe and the outer sleeve can be greatly reduced during extending, so that the service life of the overall telescopic water pipe is prolonged. Meanwhile, the corrugated pipe has a better water pressure resisting effect compared with a general silicon pipe, which can also prolong the service life of the overall pipe body.

### BRIEF DESCRIPTION OF DRAWINGS

In order to more clearly describe the embodiments of the present disclosure or the technical solutions in the related art, the drawings working in the description of the embodiments or the related art will be briefly described below. It is apparent that the drawings in the following description are only some embodiments of the present disclosure, and other drawings can be obtained by those skilled in the art according to these drawings without any creative work.

FIG. 1 is a main view of a telescopic water pipe of the present disclosure;

FIG. 2 is a sectional view of a telescopic water pipe of the present disclosure;

FIG. 3 is a vertical view of a first connector in the telescopic water pipe of the present disclosure;

FIG. 4 is a vertical view of a second connector in the telescopic water pipe of the present disclosure; and

FIG. 5 is a schematic diagram of weaving a woven tape and elastic filaments of the telescopic water pipe of the present disclosure.

In drawings 1 to 5: 1-first connector; 2-second connector; 3-protective sleeve; 4-outer sleeve; 5-corrugated pipe; 6-silicone gasket; 7-elastic filaments; 8-water inlet/outlet; 9-woven tape; and 10-threads.

### DETAILED DESCRIPTION OF THE EMBODIMENTS

Preferred embodiments of the present disclosure are described below in detail, so that the advantages and features of the present disclosure are more easily understood by those skilled in the art, thereby defining the scope of protection of the present disclosure more clearly and definitely.

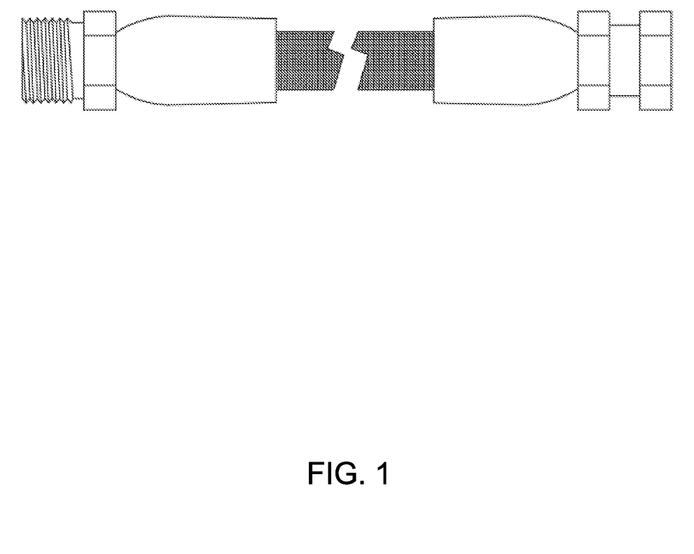

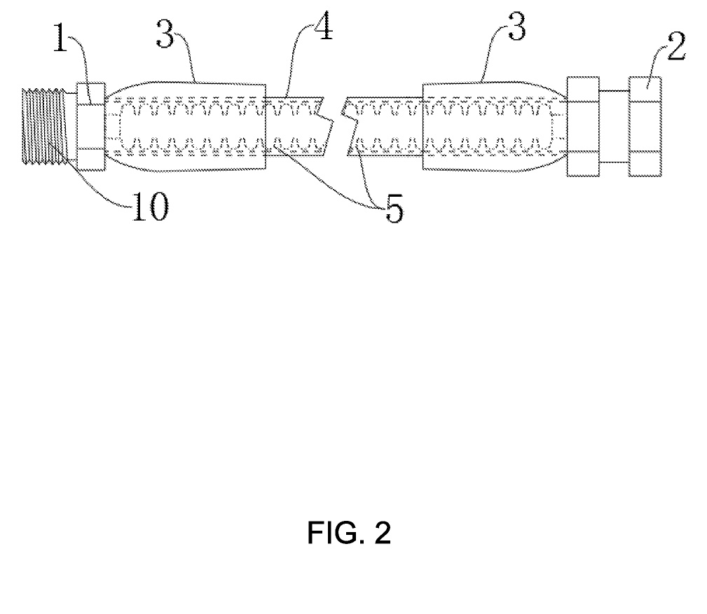

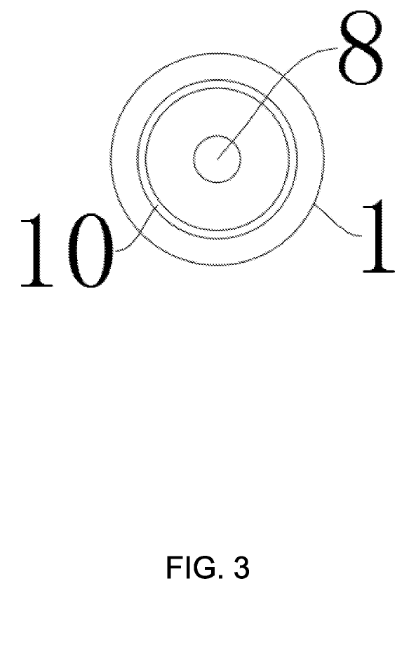

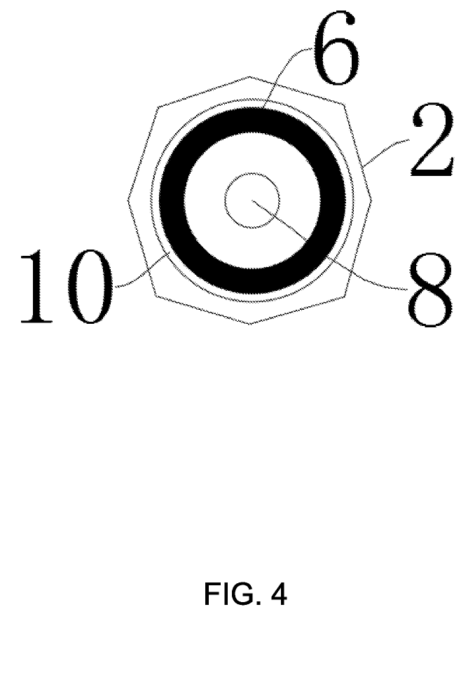

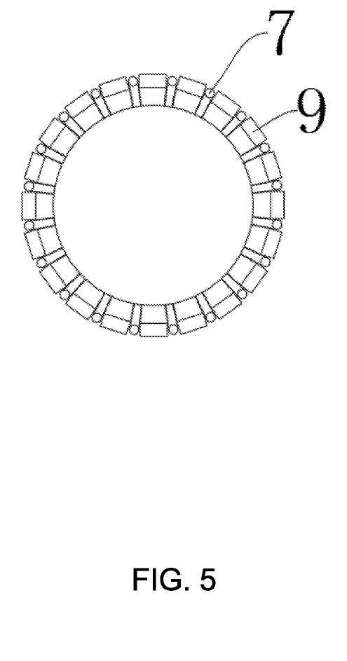

Referring to FIG. 1 to FIG. 5, a telescopic water pipe includes a first connector 1, a second connector 2, and an outer sleeve 4. Two ends on a left side and a right side of the outer sleeve 4 are respectively connected to the first connector 1 and the second connector 2. A corrugated pipe 5is also placed in the outer sleeve 4. A left end and a right end of the corrugated pipe 5 are respectively connected to the first connector 1 and the second connector 2. The outer sleeve 4 includes a woven tape 9 and elastic filaments 7. The woven tape 9 and the elastic filaments 7 are seamlessly woven into the outer sleeve 4. When water passes, the outer sleeve 4 and the corrugated pipe 5 extend horizontally to both sides.

A water inlet/outlet 8 is formed in each of the first connector 1 and the second connector 2 for water to inflow and outflow. A silicone gasket 6 is also mounted in the second connector 2 and is configured to realize better sealing property when connected to an external connecting piece, for example, realizing sealing when connected to a water faucet. The corrugated pipe 5 is a plastic corrugated pipe, and is more wear-resistant and durable compared with a silicone pipe. The woven tape 9 is made of nylon fibers, of course, may be made of other wear-resistant materials, for example, a polyester fiber material. A protective sleeve 3 is also fixed to each of the first connector 1 and the second connector 2 for preventing the fracture of deformation of the water pipe when bended for a plurality of times, which is a conventional technology.

In the present embodiment, the second connector 2 is connected to the water faucet first. Threads 10 are uniformly distributed on an outer circumferential side of the first connector 1 and an inner wall side of the second connector 2, which facilitates connection with other parts. After connection, water inflows from the second connector 2, passes through the corrugated pipe, and is discharged from the first connector 1. Of course, the first connector 1 may also be connected with a water faucet with internal threads for use. During water passing, the corrugated pipe 5 extends horizontally due to high water pressure after the water passes through the corrugated pipe 5, so that the original length of the corrugated pipe 5 can extend to more than two times. The outer sleeve 4 is formed by seamlessly weaving the woven tape 9 and the elastic filaments 7. The elastic filaments 7 may be elastic filaments made of polyester or other materials. The elastic filaments 7 have high elasticity, which changes the original poor ductility of a nylon material of the woven tape 9 to more than twice the same ductility. The woven tape 9 is made of nylon fibers, which is a high wear-resistant material. The same extension factor of the corrugated pipe 5 and the outer sleeve 4 and the high wear resistance between the two can minimize a friction coefficient and prolong the service life of the water pipe. The plastic corrugated pipe has high water pressure resistance compared with a silicon pipe, which further prolongs the service life of the water pipe. The seamlessly woven outer sleeve has higher wear resistance, less easiness in damage, and longer service life compared with an outer sleeve woven in a seamed manner.

The above descriptions are only specific implementations of the present disclosure, but the scope of protection of the present disclosure is not limited thereto. Any variation or replacement readily figured out without creative work fall within the scope of protection of the present disclosure.

What is claimed is:

1. A telescopic water pipe, comprising a first connector, a second connector, and an outer sleeve, wherein two ends on a left side and a right side of the outer sleeve are respectively connected to the first connector and the second connector; a corrugated pipe is also placed in the outer sleeve; a left end and a right end of the corrugated pipe are respectively connected to the first connector and the second connector; the outer sleeve comprises a woven tape and elastic filaments; the woven tape and the elastic filaments are seamlessly woven into the outer sleeve; and when water passes, the outer sleeve and the corrugated pipe extend horizontally to both sides.

2. The telescopic water pipe according to claim 1, wherein a water inlet/outlet is arranged on each of the first connector and the second connector.

3. The telescopic water pipe according to claim 1, wherein a silicone gasket is also mounted in the second connector.

4. The telescopic water pipe according to claim 1, wherein the corrugated pipe is a plastic corrugated pipe.

5. The telescopic water pipe according to claim 1, wherein the woven tape is made of nylon fibers.

6. The telescopic water pipe according to claim 1, wherein a protective sleeve is also fixed to each of the first connector and the second connector.
